(19) United States
(12) Patent Application Publication
(10) Pub. No.: US 2007/0022070 A1
(43) Pub. Date: Jan. 25, 2007

(54) Forgetful logic for artificial neural networks

(76) Inventors: Richard B. Wells, Moscow, ID (US); David Cox, Tucson, AZ (US); Anindya Bhattacharya, Tucson, AZ (US)

Correspondence Address: Ormiston & McKinney;Suite 400, 802 W. Bannock, P.O. Box 298, Boise, ID, 83701-0298, US

(21) Appl. No.: 11/376,382

(22) Filed: Mar. 15, 2006

Related U.S. Application Data
(60) Provisional application No. 60/662,333, filed on Mar. 15, 2005.

(51) Int. Cl. G06N 3/00; G06F 15/18; G06J 1/00

(52) U.S. Cl. 706/33

(57) ABSTRACT

An embodiment includes a plurality of tangible electronic elements interconnected to form a forgetful latch. The forgetful latch includes a pass element operable to receive input pulses; a biasing element coupled to the pass element and operable to bias a storage node charged by at least one of the input pulses; and an inverter coupled to the biasing elements and operable to produce an output pulse that stretches the input pulses.

### CROSS REFERENCE TO RELATED APPLICATION

This application claims the subject matter disclosed in the co-pending provisional application Ser. No. 60/662,333 filed Mar. 15, 2005.

This invention was funded in part by the Idaho NSF EPSCoR and the National Science Foundation under Contract No. EPS-0132626. The United States Government has certain rights in the invention.

### BACKGROUND

Artificial neural networks (ANN) are used in computing environments where mathematical algorithms cannot describe a problem to be solved. ANNs are often used for speech recognition, optical character recognition, image processing, and numerous other mathematically ill-posed computation and signal processing problems. ANNs are able to learn by example and, when receiving an unrecognized input signal, can generalize based upon past experiences.

There is very strong biological evidence that signal-dependent elastic modulation of synaptic weights and neuronal excitability plays a key role in information processing in the brain. Relatively rapid, short-term variations in synaptic efficacy is now believed to be responsible for a transient and reconfigurable ‘functional column’ organization in the visual cortex. Dynamical recruitment of neurons into functional units by various selection processes have been theoretically studied by many. Transient elastic modulation of synaptic efficacy is a central feature in the dynamic link architecture paradigm of neural computing. One well-known example of the use of elastic modulation is provided by the vigilance parameter in ARTMAP networks. It has long been accepted that firing rate encoding is one method by which information can be presented in a pulse-mode neural network, and it is likewise known that rate-dependent mechanisms exist in biological neural networks that filter information based on both pulse rate and the duration of a signaling tetanus. Similarly, information may also be encoded through synchrony of firing patterns, and it is obvious that synchrony and rate/duration encoding can be combined in determining elastic modulations of synaptic efficacy. Many biological synapses, for instance, show selectivity to both pulse repetition rate and tetanus duration.

### DESCRIPTION OF THE DRAWINGS

FIG. 1 is a circuit diagram of an exemplary non-inverting forgetful latch according to an embodiment of the present invention.

FIG. 2 is a graph illustrating pulse rate dependence of the forgetful latch of FIG. 1.

FIG. 3 is a circuit diagram of an exemplary forgetful flip-flop according to an embodiment of the present invention.

FIG. 4 is a graph illustrating input/output responses for 333 kpps and 400 kpps input pulse rates for the forgetful flip-flop of FIG. 3 designed to produce a facilitation response.

FIG. 5 is a graph illustrating an FFF output pulse width vs. input pulse rate for a continuous input tetanus of 1 psec-wide input pulses for the circuit of FIG. 3.

FIG. 6 is a circuit diagram of an exemplary potentiating forgetful flip-flop according to an embodiment of the present invention.

FIG. 7 is a graph illustrating a response of the circuit of FIG. 6.

FIG. 8 is a block diagram of a forgetful flip-flop used to increase the sensitivity of a biomimic artificial neuron according to an embodiment of the present invention. A HIGH output from the forgetful flip-flop adds a DC bias to the input of the leaky integrator in the biomimic artificial neuron. This additional bias decreases the number of synchronous synaptic inputs required to evoke an action potential from the biomimic artificial neuron.

FIG. 9 is a graph illustrating waveforms for augmentation of firing sensitivity of a biomimic artificial neuron. The top trace shows the two synchronous synaptic inputs to the biomimic artificial neuron. The second trace shows the input to the forgetful flip-flop. The third trace is the forgetful flip-flop output. The bottom trace is the biomimic artificial neuron output. By replacing the forgetful flip-flop with a long term memory forgetful flip-flop, augmentation of firing sensitivity can be maintained for a longer time period after the forgetful flip-flop input ceases.

FIG. 10 is a block diagram of a forgetful flip-flop used as feedback to an inhibitory synapse of a biomimic artificial neuron to accommodation in the output firing rate of the neuron according to an embodiment of the present invention. A high-rate output at B eventually induces a high output from the forgetful flip-flop, which is fed back to an inhibitory synapse. This feedback lowers the firing rate at B. If firing rate B is slowed sufficiently, the forgetful flip-flop will eventually go inactive, thereby re-enabling the higher firing rate.

FIG. 11 is a block diagram of forgetful logic circuits used to convert a biomimic artificial neuron integrate-and-fire cell into a bursting cell according to an embodiment of the present invention. A forgetful latch is applied to an excitatory synapse having a synaptic weight high enough to ensure re-firing of the biomimic artificial neuron. After a burst length determined by the design of the forgetful flip-flop, forgetful flip-flop signal C is asserted at an inhibitory synapse. The weight of this synapse is set sufficiently high to ensure that C inhibits further firing. Firing at B can resume after the forgetful flip-flop output discharges and returns to the LOW state.

FIG. 12 is a block diagram of a forgetful logic circuit used to help mimic the linking field effect of an Eckhorn neural network according to an embodiment of the present invention. It is to be noted that in most reported Eckhorn network designs, the linking field time constant is short compared to the feeding field time constant. This requirement is satisfied by the relatively short pulse duration of the forgetful latch of FIG. 2.

FIG. 13 is a block diagram of a forgetful flip-flop used for short term synaptic weight modulation according to an embodiment of the present invention. The standard synaptic input of a biomimic artificial neuron is modified by adding an additional control input to which the forgetful flip-flop is connected. When the forgetful flip-flop output goes HIGH, this input switches additional current to the synaptic input, thereby increasing the synaptic weight. The actual application of synaptic current to the biomimic artificial neuron's leaky integrator is controlled by the direct connection to the source biomimic artificial neuron. The forgetful flip-flop output goes high only in response to a tetanus at its input of sufficiently high frequency to invoke an output response from the forgetful flip-flop.

### DETAILED DESCRIPTION

The following description provides examples of circuits for implementing elastic modulation features in pulse-mode artificial neural networks. Examples are also provided that illustrate the use of the circuits with some examples of selective rate- and tetanus-duration in mixed-signal VLSI pulse-mode neurons networks. The exemplary circuits are selective for ranges of input firing rates and number of pulses received. As discussed below, if the firing rate is below the selection range, the circuits do not activate. Within the designed frequency range the circuits require a minimum number of incoming pulses before activation.

The circuits are based on a logic circuit consisting of a pass element, inverters, and biasing elements that set its dynamic characteristics. Circuits based on this design are referred to as “forgetful logic” circuits (FLCs). Forgetful Logic designates a family of asynchronous logic circuits particularly well suited for the design and implementation of pulse-coded artificial neural networks in standard VLSI technology. Employment of forgetful logic circuits in a neural network design is used to design a variety of neural functions including but not limited to central pattern generators for control of the timing of neural subassemblies, short-term modulation of synaptic weights for enhanced information processing, and implementation of dynamic links in correlation-coding of neural network information.

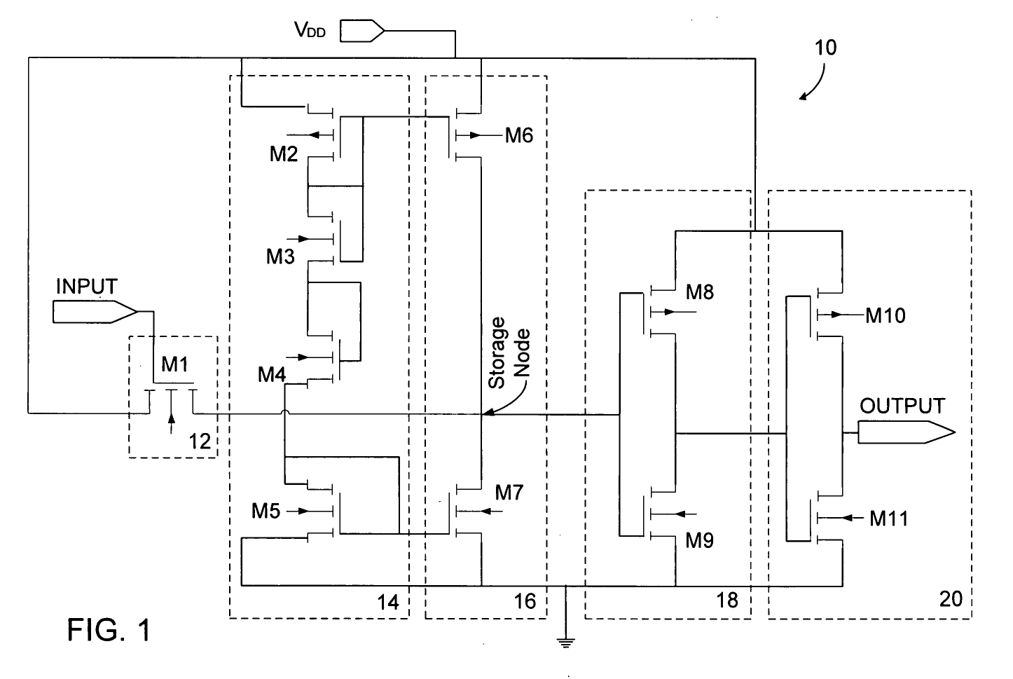

Forgetful Logic Latch: The basic logic element is the non-inverting forgetful latch (FL) depicted in FIG. 1. As shown, FL 10 includes pass element 12, biasing elements 14 and 16, and inverters 18 and 20. In the example of FIG. 1, pass element 12 includes transistor M1. Transistors M2-M5 make up biasing element 14 and are referred to as a “biasing stick.” Biasing element 14 can be common to several FLCs in a VLSI implementation. M6 and M7 make up the biasing element 16 and function to bias a storage node located at the gates of M8-M9—inverter 18. Inverter 20 is made up of transistors M10 and M11.

A single high-level input pulse applied to M1 charges the storage node to V_{DD} and results in a HIGH level output from inverter 20 (M10-M11). When the input pulse goes LOW, M1 opens and current source M7 slowly discharges the gate capacitance of M8 and M9 at the storage node. The output pulse remains high for a brief time determined by that gate capacitance and the value of the drain current of M7. Thus, the input pulse is briefly ‘stretched’ at the output (for about 2.89 μsec for a 1 μsec input pulse in one implementation) beyond the end of the input pulse. FL 10 then “forgets” and the output goes LOW again.

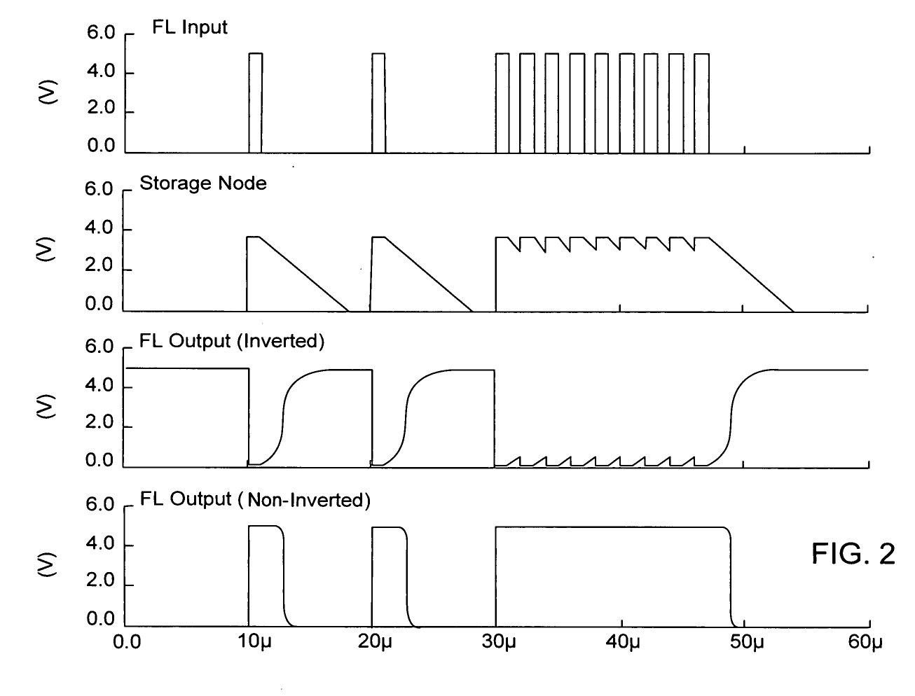

FIG. 2 illustrates the response of FL 10 to isolated input pulses and to a high-frequency tetanus. Note that for high-rate input pulse trains, FL 10 maintains a constant HIGH output level. This behavior signals the on-going presence of signaling activity at the input of FL 10 and is a characteristic used in constructing various other signal processing functions implemented using forgetful logic. The output pulse width of FL 10 for a single isolated input pulse is given by

$$τ = \frac{C ( {V}_{DD} - {V}_{SP} - {V}_{t} )}{I} + {τ}_{in}$$

where τ is the output pulse width, C is the total gate capacitance at the storage node, V_{DD} is the power supply voltage, V_{SP} is the switching threshold of M8-M9, Vₜ is the threshold of the n-channel device, I is the drain current of M7, and τᵢₙ is the width of the input pulse. The input pulse rate at which the constant response at the output is obtained is given by 1/(τ+τᵢₙ).

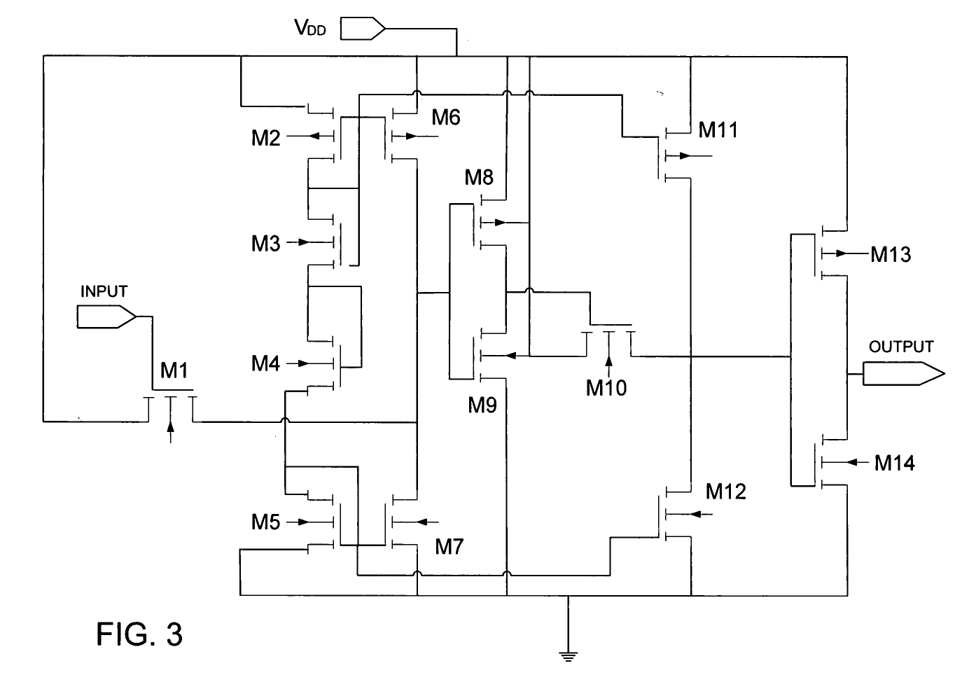

Forgetful Flip-flop: A Forgetful Flip-flop (FFF) can be constructed from the cascade of two inverting forgetful latches—typically with different design values for τ. The circuit, FFF 22, is shown in FIG. 3. The first forgetful latch is made from pass element 12, biasing elements 14 and 16, and inverter 18. The second forgetful latch is made from pass element 24, biasing elements 14 and 26, and inverter 28. As with FIG. 1, pass element 12 includes transistor M1, biasing element 14 includes transistors M2-M5, biasing element 16 includes transistors M6 and M7, and inverter 18 includes transistors M8 and M9. For the second forgetful latch, pass element 24 includes transistor M12, biasing element 26 includes transistors M13 and M14, and inverter 28 includes transistors M15 and M16.

Under quiescent conditions the output is LOW and the storage node at the drain of M14 is charged to V_{DD} . τ at M14 is set to be larger than that of M7 such that the second forgetful latch cannot respond to single input pulses at the gate of M1. Rather, an input tetanus is required before FFF 22 will respond.

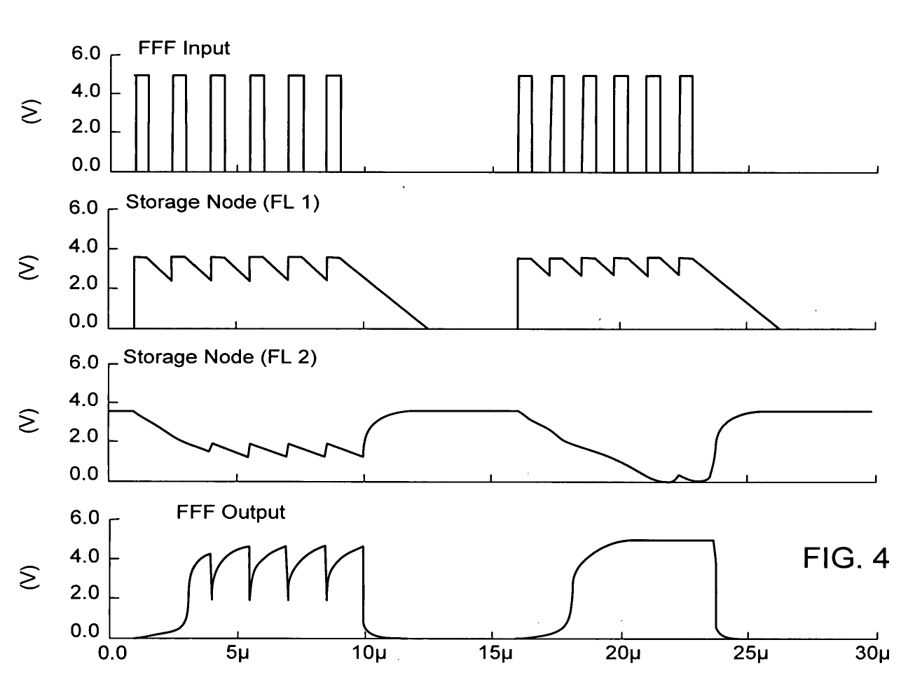

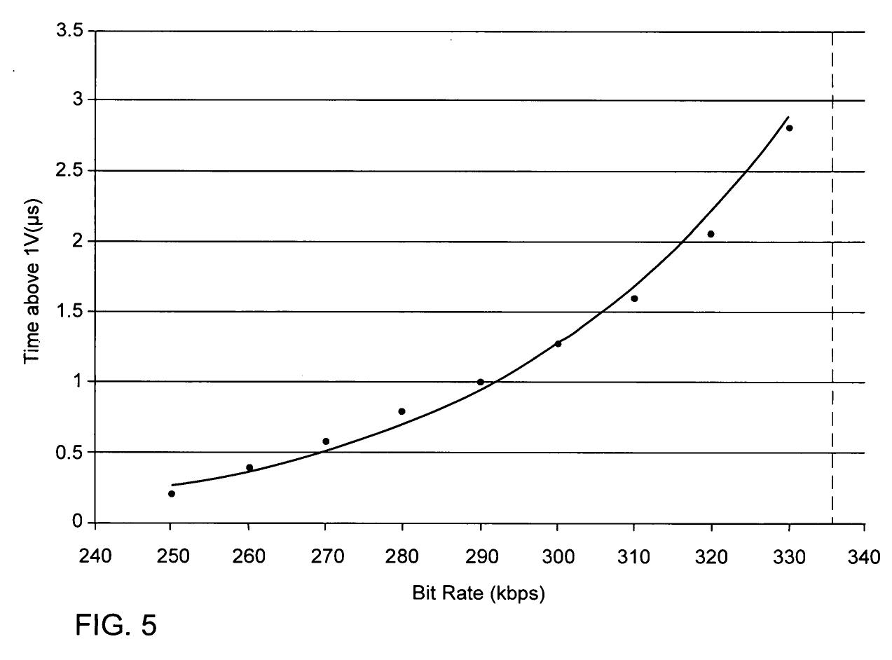

The number of input pulses in the tetanus and the minimum input pulse rate required to evoke an output response from FFF 22 depends on the relative values of τ for the two stages. It is possible to achieve a wide range in the length of the tetanus required and in the delay-to-output assert and pulse width of FFF 22 output pulse. As a matter of terminology, we refer to FFF 22 designs that respond relatively quickly and have output pulses that reset shortly after the end of the tetanus as a “facilitation” response; designs that require a longer tetanus or which hold the output pulse HIGH for a longer period of time after the end of the tetanus are called “augmentation” responses. The basic action of FFF 22 is illustrated in FIG. 4 for a design that implements a facilitation response. In an exemplary implementation, the FFF 22 circuit which produces this response ignores input pulse trains that arrive at a pulse rate of less than 200 kpps and has a peak output response of only 1 volt for input pulse rates of 250 kpps when the input pulses are 1 μsec wide. The input pulse rates shown in this figure are 333 kpps and 400 kpps, respectively. FIG. 5 graphs the time FFF 22 output remains above 1 volt as a function of input pulse rate for input pulses of 1 μsec width. (1 volt is the minimum synapse threshold for the artificial neurons used as application examples in the section to follow).

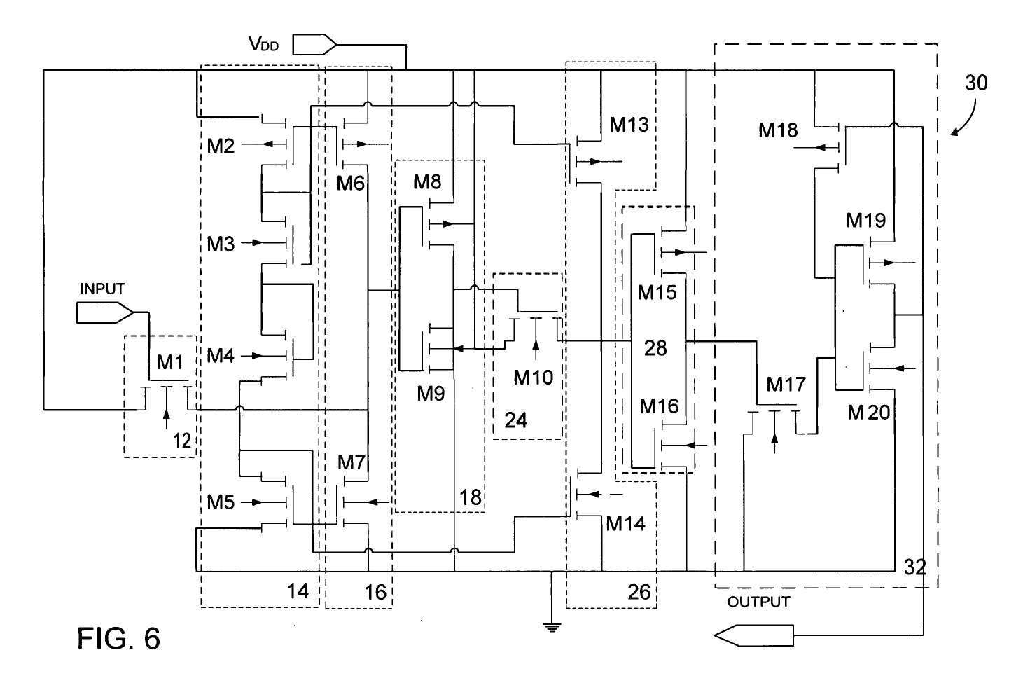

A simple addition to FFF 22 of FIG. 3 produces the ability to maintain an active HIGH-level output signal for a sizable fraction of a second. The circuit, long-term memory FFF 30 (LT-FFF), is shown in FIG. 6 where M1-M16 comprise a standard FFF such as FFF 22 in FIG. 3. M17-M20 implement a long-term memory element 32. Under quiescent conditions, a LOW-level output turns on “keeper” transistor M18 and keeps the storage node at M19-M20 charged to V_{DD}. When a HIGH-level input is applied to M17, the storage node is discharged and the output goes HIGH. After the gate of M17 returns to a LOW value, leakage current through M18 slowly recharges the storage node. The storage time for LT-FFF 30 is determined by the switching threshold VSP for M20. The response of this circuit is called a “potentiation” response.

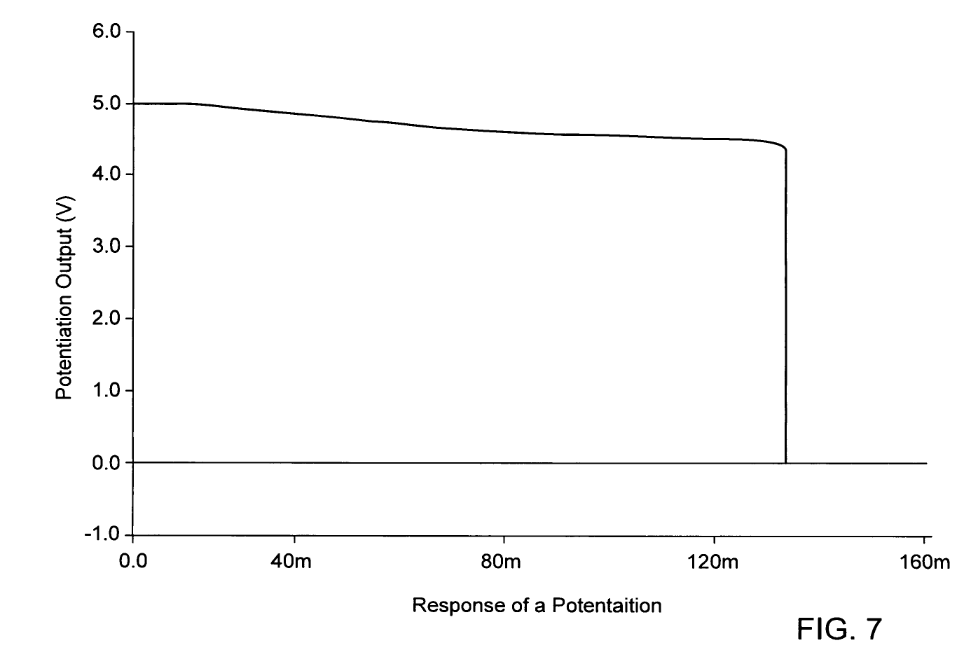

FIG. 7 illustrates a typical potentiation response. An input tetanus of 1 μsec pulses at 500 kpps was applied to the circuit of FIG. 6 for 18 μsec. The tetanus was then terminated. The LT-FFF 30 output went high at approximately 10 μsec and maintained this high-level output state for 132 msec. In exemplary implementations LT-FFF 30 has been designed for potentiation response in the range from about 20 msec up to the response illustrated in FIG. 7.

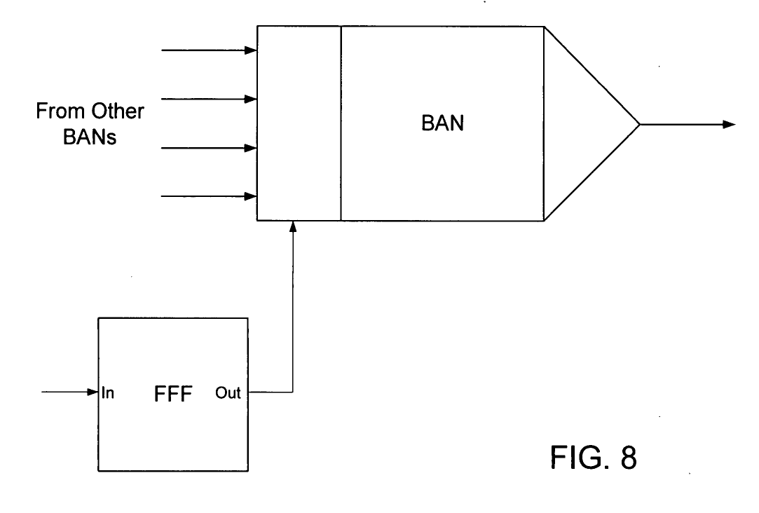

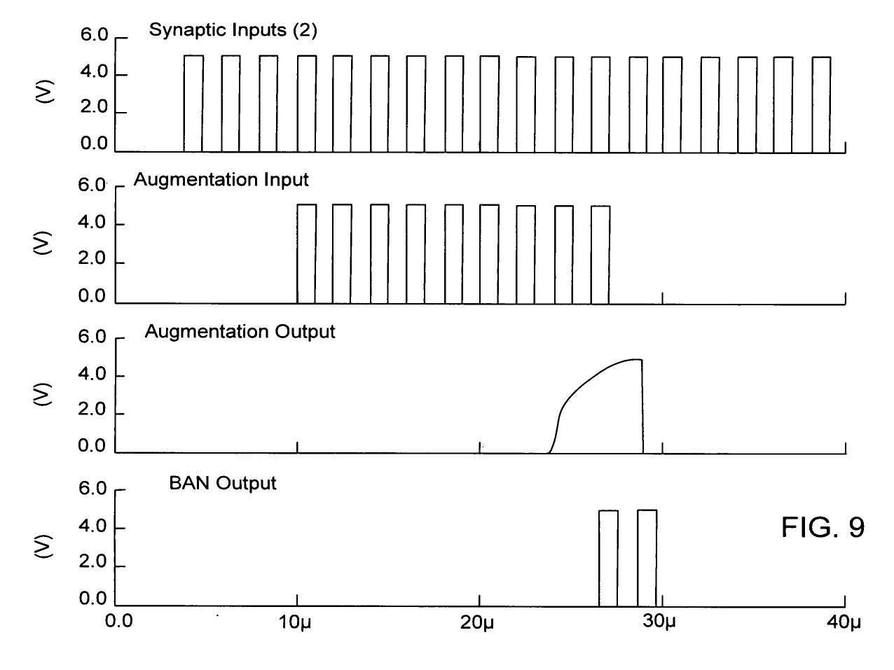

Applications in Forgetful Logic: This section helps illustrate some of the applications of forgetful logic in pulse-mode neural networks. The neuron element used is a previously reported design known as a biomimic artificial neuron (BAN). For this, U.S. patent application Ser. No. 10/893,407 entitled “Biomimic Artificial Neuron” is incorporated by reference in its entirety. The first application is the use of an FFF to increase the sensitivity of a neuron to excitatory synaptic inputs. The circuit is illustrated in FIG. 8. The BAN was designed such that a minimum of four synchronous synaptic inputs is required to fire an action potential (AP). An FFF output is applied to a synaptic input with the synaptic weight set such that: 1) the FFF cannot by itself stimulate an AP from the BAN, and 2) when the FFF input is HIGH two other synchronous synaptic inputs suffice to produce an AP. FIG. 9 shows two synchronous BAN inputs, the input pulse train of the FFF, the FFF output, and the BAN output. In this illustration, the FFF was designed to respond after a 7-pulse tetanus at 500 kpps before augmenting the sensitivity of the BAN. The augmentation input would remain applied so long as the FFF continued to receive the input tetanus. By replacing the FFF with a LT-FFF, augmentation of the BAN inputs can be maintained for a much longer period of time after the FFF input ceases. This technique can be used to enable specific cell groups of BAN neurons to implement re-configurable neurocomputing functional units. Similarly, by applying the FFF output to an inhibitory BAN input, the sensitivity of the BAN to synaptic inputs is reduced and, if the inhibitory weight of the BAN is large enough, can even be suppressed entirely (disabling of BAN cell assemblies). It should also be noted that because the FFF acts as a filter to low firing-rates, the augmentation action can be made frequency-selective. This has potential application for rate-dependent binding code specifications in pulse-mode neural networks.

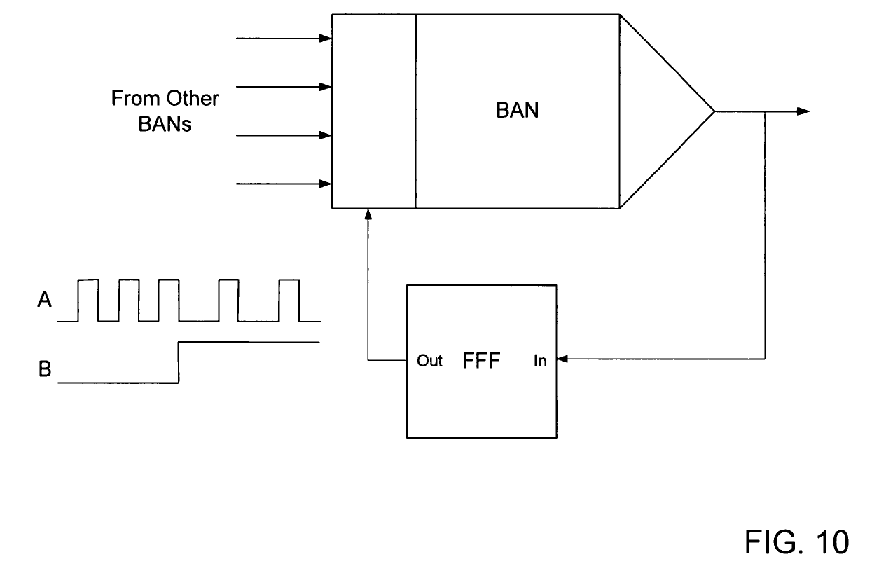

A variation on this scheme can be used to produce an accommodation response from a BAN neuron. This is illustrated in FIG. 10. Assume that a firing response is induced in the BAN such that the firing rate at B is high enough to invoke a response in the FFF. When the FFF output goes HIGH, its signal is applied to an inhibitory synaptic input at the BAN, thereby reducing the BAN firing rate. This mode of pulse coding is called an accommodation response by biologists and is frequently observed in numerous biological neurons. If the rate at B is reduced sufficiently (by selection of the inhibitory synaptic weight), the FFF, which acts as a high-pass rate filter, will eventually de-assert its output, thereby re-enabling the higher firing rate.

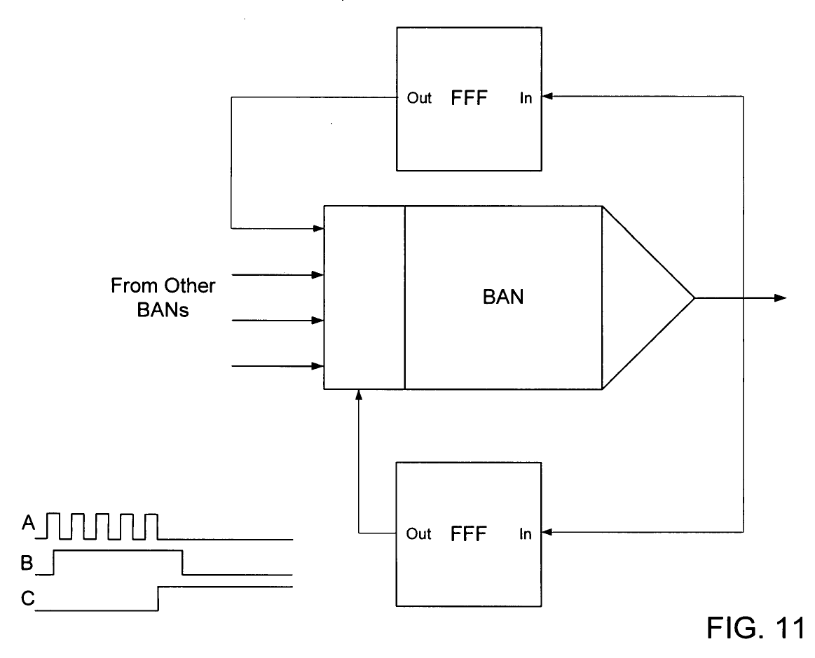

By combining positive feedback from a FL with negative feedback from an FFF, a BAN can be made to exhibit burst firing patterns. This is illustrated in FIG. 11. Here the synaptic weight at A is set high enough such that the FL signal invokes an AP from the BAN. Because the FL output pulse is wider than that of the BAN, the BAN re-triggers after its refractory period and maintains firing.

After a number of pulses at B determined by the design of the FFF, the output at C is asserted at an inhibitory synapse. The synaptic weight of this synapse is set high enough to ensure that C completely inhibits further firing. After the FFF discharges, C is de-asserted and the BAN can again respond to its other synaptic inputs.

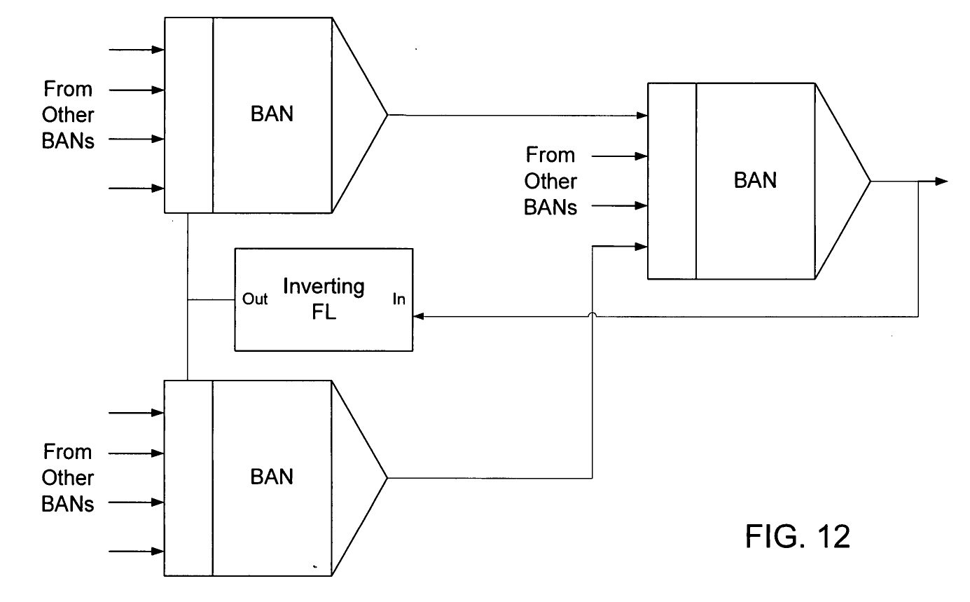

The BAN design responds to inhibitory synaptic inputs differently than excitatory synapses. In particular, the response time for inhibitory BAN inputs is faster than that of the excitatory synapses because of the method used to discharge the BAN's leaky integrator (LI). This difference can be exploited to obtain the linking field behavior of an Eckhorn neural network using integrate-and-fire BAN devices. The scheme is illustrated in FIG. 12. An inverting FL is used as the feedback device from the second layer of the Eckhorn network. Its output is therefore normally HIGH and is applied to inhibitory synapses in the first (and elsewhere in the second) layer. The synaptic weight of this input is set so that it is not high enough to prevent the BANs from firing in response to sufficient excitation of their synaptic inputs. When the second-layer BAN fires, the output of the inverting FL is de-asserted, which effectively raises the sensitivity of the BANs to their excitatory inputs. This mimics the linking field effect of a conventional Eckhorn neuron.

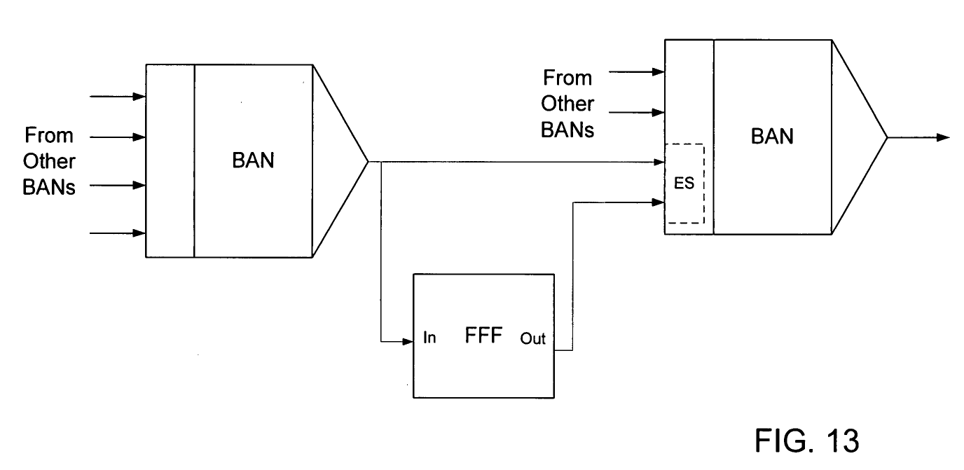

As a final application example, an FFF can be used to obtain short-term modulation of synaptic weights. The scheme is illustrated in FIG. 13. To implement weight modulation, a trivial modification must be made to the standard BAN synaptic input. In a standard BAN design, a HIGH level input at a synapse switches current to an internal summing resistor at which the voltage input to the BAN's LI is obtained. To make an elastic synapse (ES), all that is required is that a second switch, which routes additional current through the main synaptic switch, be added. When the FFF output goes HIGH, this switch is activated, thereby adding to the synaptic current produced by the direct connection between BANs. The synaptic weight of a BAN is determined by the total current switched to the summing resistor. With a periodic or low-rate input pulses, the FFF output remains LOW. However, the FFF will respond to a high-frequency tetanus by asserting its output as shown in the earlier figures.

Conclusion: The previous description introduced forgetful logic and illustrated its application to pulse-mode neural networks. The well-known integrate-and-fire neuron has for many years been the most popular hardware implementation for artificial neurons owing to its simplicity. However, it has also been long recognized that the integrate and fire neuron is somewhat limited in the types and methods of information encoding it is capable of achieving. Forgetful logic has been developed in order to provide a richer repertoire of signal encoding capabilities and to provide a relatively simple means of short-term synaptic weight modulation to support work in dynamic link architectures.

1. A forgetful latch, comprising a plurality of tangible electronic elements interconnected to form:
a pass element operable to receive input pulses;
a biasing element coupled to the pass element and operable to bias a storage node charged by at least one of the input pulses; and
an inverter coupled to the biasing elements and operable to produce an output pulse that stretches the input pulses.

2. The forgetful latch of claim 1, wherein the pass element comprises a first transistor having a gate, a drain, and a source wherein the gate defines an input for the input pulses, the source is coupled to the biasing element and the inverter, and the drain is coupled to the biasing element to define the storage node.

3. The forgetful latch of claim 2, wherein the biasing element comprises a first biasing element and a second biasing element, wherein:
the first biasing element comprises a second transistor, a third transistor, a fourth transistor, and a fifth transistor, each having a gate, a drain, and a source, wherein:
the source of the second transistor is coupled to the source of the first transistor;
the drain of the second transistor is coupled to the source of the third transistor, the gate of the second transistor, and the gate of the third transistor;
the drain of the third transistor is coupled to the source of the fourth transistor and the gate of the fourth transistor;
the drain of the fourth transistor is coupled to the source of the fifth transistor and the gate of the fifth transistor;
the second biasing element comprises a sixth transistor and a seventh transistor, each having a gate, a drain, and a source, wherein:
the drain of the sixth transistor is coupled to the source of the first transistor;
the gate of the sixth transistor is coupled to the gate of the second transistor;
the source of the sixth transistor is coupled to the drain of the seventh transistor and the drain of the first transistor and defines the storage node;
the gate of the seventh transistor is coupled to the gate of the fifth transistor;
the source of the seventh transistor is coupled to the drain of the fifth transistor.

4. The forgetful latch of claim 3, wherein the inverter comprises a first inverter and a second inverter, wherein:
the first inverter comprises an eighth transistor and a ninth transistor, each having a gate, a drain, and a source, wherein:
the drain of the eighth transistor is coupled to the source of the first transistor;
the gate of the eighth transistor is coupled to the gate of the ninth transistor and to the storage node;
the source of the eighth transistor is coupled to the drain of the ninth transistor;
the source of the ninth transistor is coupled to the source of the seventh transistor;
the second inverter comprises an tenth transistor and eleventh transistor, each having a gate, a drain, and a source, wherein:
the drain of the tenth transistor is coupled to the source of the first transistor;
the gate of the tenth transistor is coupled to the gate of the eleventh transistor and to the source of the eighth transistor;
the source of the tenth transistor is coupled to the drain of the eleventh transistor and defines an output for the output pulse;
the source of the eleventh transistor is coupled to the source of the ninth transistor.

5. A forgetful flip flop comprising a plurality of tangible electronic elements interconnected to a first forgetful latch coupled to a second forgetful latch, wherein:
the first forgetful latch includes:
a first forgetful latch pass element operable to receive input pulses;
a first forgetful latch biasing element coupled to the first forgetful latch pass element and operable to bias a first storage node charged by at least one of the input pulses; and
a first forgetful latch inverter coupled to the first forgetful latch biasing element and operable to produce an output first output stretches the input pulses.
the second forgetful latch includes:
a second forgetful latch pass element operable to receive the first output;
a second forgetful latch biasing element coupled to the second forgetful latch pass element and operable to bias a second storage node charged by the first output; and
a second forgetful latch inverter coupled to the second forgetful latch biasing element and operable to produce a second output that stretches the first output.

6. The forgetful flip flop of claim 5, wherein the first forgetful latch pass element comprises a first transistor having a gate, a drain, and a source wherein the gate defines an input for the input pulses, the source is coupled to the first forgetful latch biasing element and the first forgetful latch inverter, and the drain is coupled to the first forgetful latch biasing element to define the first storage node.

7. The forgetful flip flop of claim 6, wherein the first forgetful latch biasing element comprises a first biasing element and a second biasing element, wherein:
the first biasing element comprises a second transistor, a third transistor, a fourth transistor, and a fifth transistor, each having a gate, a drain, and a source, wherein:
the source of the second transistor is coupled to the source of the first transistor;
the drain of the second transistor is coupled to the source of the third transistor, the gate of the second transistor, and the gate of the third transistor;
the drain of the third transistor is coupled to the source of the fourth transistor and the gate of the fourth transistor;
the drain of the fourth transistor is coupled to the source of the fifth transistor and the gate of the fifth transistor;
the second biasing element comprises a sixth transistor and a seventh transistor, each having a gate, a drain, and a source, wherein:
the drain of the sixth transistor is coupled to the source of the first transistor;
the gate of the sixth transistor is coupled to the gate of the second transistor;
the source of the sixth transistor is coupled to the drain of the seventh transistor and the drain of the first transistor and defines the first storage node;
the gate of the seventh transistor is coupled to the gate of the fifth transistor;
the source of the seventh transistor is coupled to the drain of the fifth transistor.

8. The forgetful flip flop of claim 7, wherein the first forgetful latch inverter comprises an eighth transistor and a ninth transistor, each having a gate, a drain, and a source, wherein:
the drain of the eighth transistor is coupled to the source of the first transistor;
the gate of the eighth transistor is coupled to the gate of the ninth transistor and to the first storage node;
the source of the eighth transistor is coupled to the drain of the ninth transistor;
the source of the ninth transistor is coupled to the source of the seventh transistor.

9. The forgetful flip flop of claim 8, wherein the second forgetful latch pass element includes a twelfth transistor having a gate, a drain, and a source wherein the gate defines an input for the first output, the source is coupled to the source of the first transistor, the second forgetful latch biasing element, and the second forgetful latch inverter, and the drain is coupled to the second forgetful latch biasing element to define the second storage node.

10. The forgetful flip flop of claim 9, wherein the second latch biasing element comprises the first biasing element and a third biasing element, wherein:
the third biasing element comprises a thirteenth transistor and a fourteenth each having a gate, a drain, and a source, wherein:
the drain of the thirteenth transistor is coupled to the source of the first transistor;
the gate of the thirteenth transistor is coupled to the gate of the second transistor;
the source of the thirteenth transistor is coupled to the drain of the seventh transistor and the drain of the twelfth transistor and defines the second storage node;
the gate of the fourteenth transistor is coupled to the gate of the fifth transistor;
the source of the fourteenth transistor is coupled to the drain of the fifth transistor.

11. The forgetful flip flop of claim 10, wherein the second forgetful latch inverter comprises a fifteenth transistor and a sixteenth transistor, each having a gate, a drain, and a source, wherein:
the drain of the fifteenth transistor is coupled to the source of the first transistor;
the gate of the fifteenth transistor is coupled to the gate of the sixteenth transistor and to the second storage node;
the source of the fifteenth transistor is coupled to the drain of the sixteenth transistor and defines an output for the second output;
the source of the sixteenth transistor is coupled to the source of the fourteenth transistor.

12. The forgetful flip flop of claim 11, further comprising a long term memory element coupled to the second forgetful latch and operable to maintain the second output at a high level for a period of time.

13. The forgetful flip flop of claim 12, wherein the long term memory element comprises a seventeenth transistor, an eighteenth transistor, a nineteenth transistor, and a twentieth transistor, each having a gate, a drain, and a source, wherein:
the gate of the seventeenth transistor is coupled to the source of the fifteenth transistor;
the drain of the seventeenth transistor is coupled to the drain of the eighteenth transistor and the gates of the nineteenth and twentieth transistors;
the source of the seventeenth transistor is coupled to the source of the sixteenth transistor and the source of the twentieth transistor;
the source of the eighteenth transistor is coupled to the drain of the fifteenth transistor and the drain of the nineteenth transistor;
the gate of the eighteenth transistor is coupled to the source of the nineteenth transistor and drain of the twentieth transistor.

14. The forgetful flip flop of claim 5, further comprising a long term memory element coupled to the second forgetful latch and operable to maintain the second output at a high level for a period of time.
